(19) United States
(12) Patent Application Publication
(10) Pub. No.: US 2023/0350513 A1
(43) Pub. Date: Nov. 2, 2023

(54) IMAGE FORMING APPARATUS AND ELECTRONIC DEVICE

(71) Applicant: SEIKO EPSON CORPORATION, Tokyo (JP)

(72) Inventors: Chiharu KOBAYASHI, Matsumoto (JP); Toru MATSUYAMA, Matsumoto (JP)

(21) Appl. No.: 18/306,308

(22) Filed: Apr. 25, 2023

(30) Foreign Application Priority Data
Apr. 27, 2022 (JP) 2022-073395

(51) Int. Cl. G06F 3/041; G06F 3/044; H04N 1/00

(52) U.S. Cl. CPC G06F 3/0416; G06F 3/044; H04N 1/00888; H04N 1/00392

(57) ABSTRACT

An image forming apparatus includes a display, a capacitive touch panel, a transporter, an image forming unit, a power supplier, the touch panel, the transporter, and the image forming unit, and a controller, the touch panel, the transporter, the image forming unit, and the power supplier, wherein the controller is configured to control a first mode in which the power supplier is controlled so that power is supplied to the display, the touch panel, the transporter, and, the image forming unit and a second mode in which the power supplier is controlled so that a power supply to the display, the transporter, and the image forming unit is restricted and power is supplied to the touch panel, and wherein an amount of power supplied to the touch panel in the second mode is smaller than an amount of power supplied to the touch panel in the first mode.

The present application is based on, and claims priority from JP Application Serial Number 2022-073395, filed Apr. 27, 2022, the disclosure of which is hereby incorporated by reference herein in its entirety.

### BACKGROUND

### 1. Technical Field

The present disclosure relates to an image forming apparatus and an electronic device.

### 2. Related Art

There is a widely known a technique for improving the operability by the user of an image forming apparatus by installing a touch panel for receiving instructions from the user in the image forming apparatus that forms an image by applying a color material to a medium. For example, JP-A-p2011-242910 describes a technique that enables improvement in user operability of an image forming apparatus by mounting a capacitive touch panel on the image forming apparatus.

However, in the image forming apparatus equipped with a capacitive touch panel, when a color material is applied to a medium, the color material may float in the image forming apparatus and may be attached to the capacitive touch panel. When the color material is attached to the touch panel, there is a possibility that the touch panel will malfunction.

In addition, in various electronic devices other than image forming apparatuses, such as a display device equipped with a capacitive touch panel, there is a possibility that dust is attached to the touch panel and causes malfunction of the touch panel, as in the case of the image forming apparatus.

### SUMMARY

According to an aspect of the present disclosure, an image forming apparatus includes a display that displays information to a user, a capacitive touch panel that receives an instruction from a user, a transporter that transports a medium, an image forming unit that forms an image by applying a color material to the medium, a power supplier that supplies power to the display, the touch panel, the transporter, and the image forming unit, and a controller that controls the display, the touch panel, the transporter, the image forming unit, and the power supplier, wherein the controller is configured to control a first mode in which the power supplier is controlled so that power is supplied from the power supplier to the display, the touch panel, the transporter, and the image forming unit, and a second mode in which the power supplier is controlled so that a power supply from the power supplier to the display, the transporter, and the image forming unit is restricted, and power is supplied from the power supplier to the touch panel, and wherein an amount of power supplied from the power supplier to the touch panel in the second mode is smaller than an amount of power supplied from the power supplier to the touch panel in the first mode.

According to an aspect of the present disclosure, an electronic device includes a display that displays information to a user, a capacitive touch panel that receives an instruction from a user, a power supplier that supplies power to the display and the touch panel, and a controller that controls the display, the touch panel, and the power supplier, wherein the controller is configured to control a first mode in which the power supplier is controlled so that power is supplied from the power supplier to the display and the touch panel and a second mode in which the power supplier is controlled so that a power supply from the power supplier to the display is restricted, and power is supplied from the power supplier to the touch panel, and wherein an amount of power supplied from the power supplier to the touch panel in the second mode is smaller than an amount of power supplied from the power supplier to the touch panel in the first mode.

### BRIEF DESCRIPTION OF THE DRAWINGS

FIG. 1 is a diagram showing an example of the appearance of a printing apparatus according to an embodiment of the disclosure.

FIG. 2 is a block diagram showing an example of the configuration of a printing apparatus.

FIG. 3 is a diagram showing an example of the configuration of a transport unit.

FIG. 4 is a block diagram showing an example of the configuration of a display.

FIG. 5 is a block diagram showing an example of the configuration of a touch panel.

FIG. 6 is a block diagram showing an example of the configuration of a detection electrode layer.

FIG. 7 is a block diagram showing an example of the configuration of a drive electrode layer.

FIG. 8 is a cross-sectional view showing an example of the configuration of a detection region.

FIG. 9 is a timing chart showing an example of the operation of a touch panel.

FIG. 10 is a timing chart showing an example of the operation of the touch panel.

FIG. 11 is a block diagram showing an example of the configuration of a detection circuit.

FIG. 12 is a block diagram showing an example of the configuration of a touch identification circuit.

FIG. 13 is a timing chart showing an example of the operation of a touch panel according to the first modification.

FIG. 14 is a timing chart showing an example of the operation of a touch panel according to the second modification.

FIG. 15 is a block diagram showing an example of the configuration of an electronic device according to the third modification.

### DESCRIPTION OF EXEMPLARY EMBODIMENTS

Hereinafter, embodiments for carrying out the present disclosure will be described with reference to the drawings. However, in each figure, the size and scale of each part are appropriately changed from the actual ones. In addition, since the embodiments described below are preferable specific examples of the present disclosure, there are various technically preferred limitations. However, the scope of the present disclosure is not limited to these embodiments unless otherwise specified in the following description.

### A. Embodiment

In the present embodiment, an image forming apparatus will be described by taking a printing apparatus 100 as an example.

### 1. Configuration of Printing Apparatus

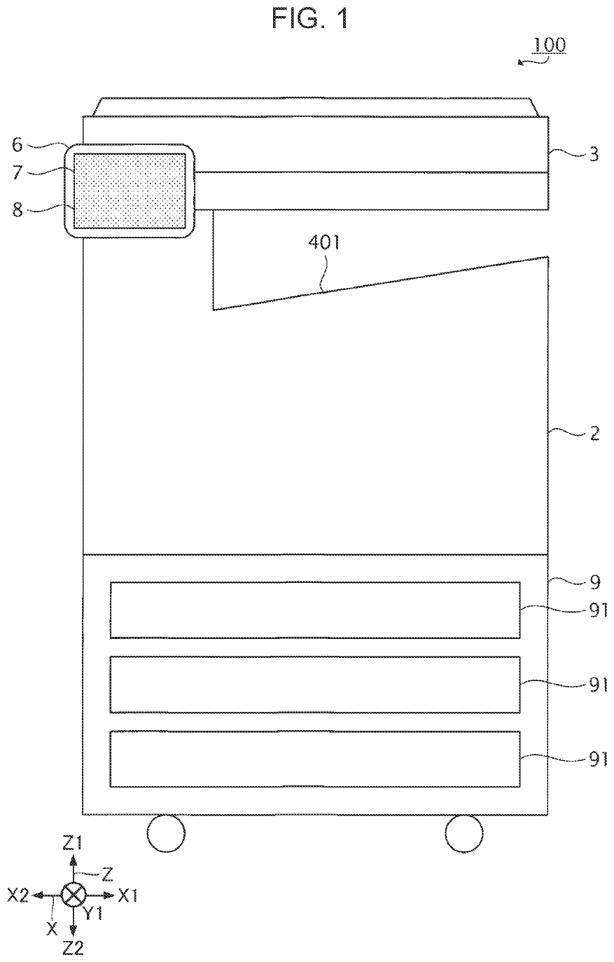

An overview of the configuration of the printing apparatus 100 according to the present embodiment will be described below with reference to FIG. 1 to FIG. 3.

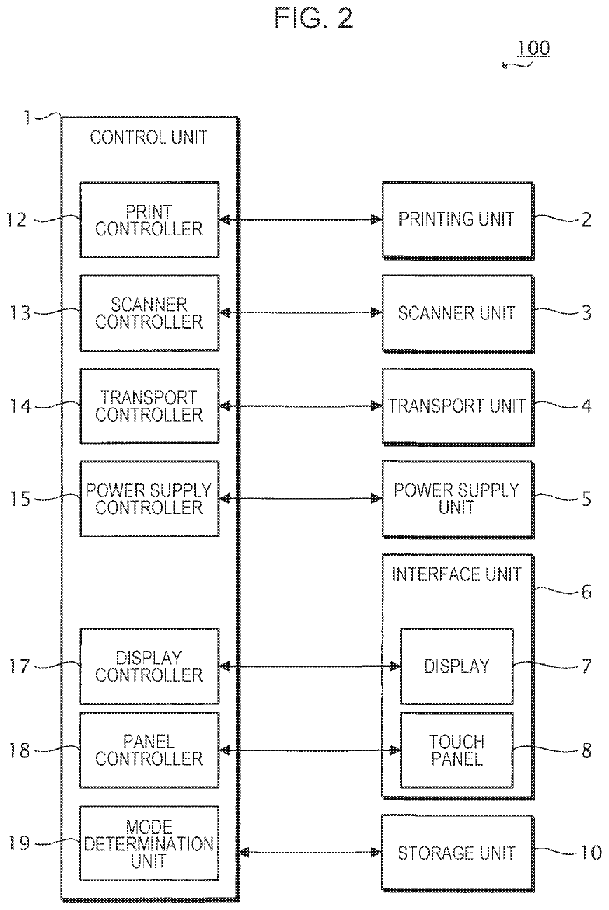

FIG. 1 is a diagram showing an example of the appearance of the printing apparatus 100. FIG. 2 is a functional block diagram showing an example of the functional configuration of the printing apparatus 100.

As shown in FIGS. 1 and 2, the printing apparatus 100 includes a control unit 1 that controls the printing apparatus 100, a printing unit 2 that executes a printing process of forming an image by ejecting ink onto print paper PP, a scanner unit 3 that executes a scanning process of reading an image formed on the print paper PP or another medium, a transport unit 4 that transports the print paper PP inside the printing apparatus 100, a power supply unit 5 that supplies power to respective components of the printing apparatus 100, an interface unit 6 including a display 7 that displays various pieces of information to the user of the printing apparatus 100 and a capacitive touch panel 8 that receives input of a command from the user of the printing apparatus 100, a paper feed unit 9 including a storage cassette 91 that stores the print paper PP, and a storage unit 10 that stores various pieces of information such as a control program for the printing apparatus 100.

Here, the control unit 1 is an example of a “controller”, the printing unit 2 is an example of an “image forming unit”, the print paper PP is an example of a “medium”, and the transport unit 4 is an example of a “transporter”, and the power supply unit 5 is an example of a “power supplier”. In the present embodiment, the ink contains pigments or dyes. In the present embodiment, the pigment or the dye contained in the ink is an example of a “color material”. Further, hereinafter, an image formed on the print paper PP by the printing unit 2 in the printing process will be referred to as a print image EP, and an image displayed on the display 7 will be referred to as a display screen EH.

As shown in FIG. 1, the printing unit 2 is provided in the Z1 direction when viewed from the paper feed unit 9. Also, the scanner unit 3 is provided in the Z1 direction when viewed from the printing unit 2. Hereinafter, the Z1 direction and the Z2 direction opposite to the Z1 direction are collectively referred to as the Z axis direction. The Z2 direction is, for example, the vertical direction. The Xl direction along the X axis that intersects the Z axis and the X2 direction opposite to the Xl direction are collectively referred to as the X axis direction. The Y1 direction along the Y axis that intersects the Z axis and the X axis and the Y2 direction opposite to the Y1 direction are collectively referred to as the Y axis direction. In the present embodiment, as an example, an explanation will be given assuming that the X axis, Y axis, and Z axis are orthogonal to each other. However, the present disclosure is not limited to such an embodiment. The X axis, Y axis, and Z axis are only required to intersect with each other.

The transport unit 4 supplies the print paper PP stored in the storage cassette 91 to the printing unit 2. Then, when the printing unit 2 forms an image on the print paper PP, the transport unit 4 discharges the print paper PP to a discharge tray 401.

The control unit 1 includes a processing circuit such as a CPU or an FPGA, and controls respective components of the printing apparatus 100. Here, the CPU is an abbreviation for a central processing unit, and the FPGA is an abbreviation for a field programmable gate array.

As shown in FIG. 2, the processing circuit provided in the control unit 1 can function as a print controller 12 that executes a control program, for the printing apparatus 100, stored in the printing apparatus 100 and operates according to the control program to control the printing unit 2, a scanner controller 13 that controls the scanner unit 3, a transport controller 14 that controls the transport unit 4, a power supply controller 15 that controls the power supply unit 5, a display controller 17 that controls the display 7, a panel controller 18 that controls the touch panel 8, and a mode determination unit 19 that determines a control mode in which the control unit 1 controls the printing apparatus 100.

In the present embodiment, the control unit 1 can control the printing apparatus 100 in a plurality of control modes including a normal operation mode and a sleep mode.

In the present embodiment, the normal operation mode is a control mode in which the control unit 1 controls the printing apparatus 100 so that the user can use all the functions provided by the printing apparatus 100 to the user. Specifically, the power supply controller 15 controls the power supply unit 5 so that power is supplied to the control unit 1, the printing unit 2, the scanner unit 3, the transport unit 4, the display 7, the touch panel 8, and the storage unit 10 in the normal operation mode. Thus, in the normal operation mode, the printing apparatus 100 can perform a printing process by the printing unit 2, a scanning process by the scanner unit 3, transport of the print paper PP by the transport unit 4, display of various pieces of information on the display 7, and reception of input of a command by the touch panel 8. In the present embodiment, a case in which the user can use all the functions provided by the printing apparatus 100 to the user in the normal operation mode will be described as an example, but the present disclosure is not limited to such an embodiment. The control unit 1 may control the printing apparatus 100 so that the user can use some of the functions provided by the printing apparatus 100 to the user in the normal operation mode.

The sleep mode is a control mode in which the control unit 1 controls the printing apparatus 100 so that the user can use, among the functions provided by the printing apparatus 100 to the user, functions fewer than those provided in the normal operation mode. Specifically, the power supply controller 15 controls the power supply unit 5 so that power is supplied to the control unit 1, the touch panel 8, and the storage unit 10, but power supply to the printing unit 2, the scanner unit 3, the transport unit 4, and the display 7 is stopped in the sleep mode. However, the present disclosure is not limited to such an embodiment. For example, the power supply controller 15 may control the power supply unit 5 in the sleep mode so that power supply to the storage unit 10 is stopped. Further, for example, the power supply controller 15 may control the power supply unit 5 so that an amount of power supplied to each of the printing unit 2, the scanner unit 3, the transport unit 4, and the display 7 in the sleep mode is restricted, and is less than an amount of power supplied to each of the printing unit 2, the scanner unit 3, the transport unit 4, and the display 7 in the normal operation mode.

In the present embodiment, the mode determination unit 19 determines the control mode to be the normal operation mode after the printing apparatus 100 is started. Then, when the control mode is the normal operation mode, the mode determination unit 19 switches the control mode from the normal operation mode to the sleep mode when the length of time of the idle period in which there is no command input from the user on the touch panel 8 is equal to or longer than a predetermined time. Further, when the control mode is the sleep mode, the mode determination unit 19 switches the control mode from the sleep mode to the normal operation mode when a command is input from the user on the touch panel 8, or when the user touches the touch panel 8.

In the present embodiment, the normal operation mode is an example of a “first mode”, and the sleep mode is an example of a “second mode”.

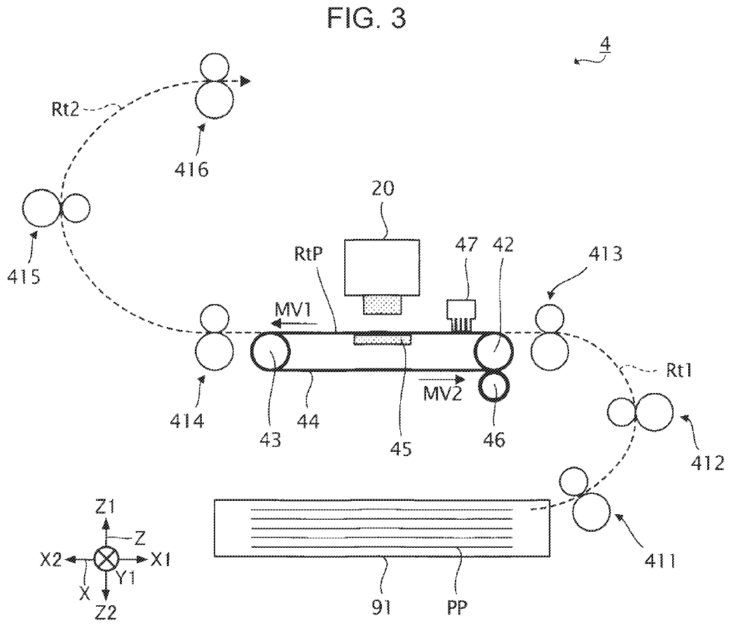

FIG. 3 is a schematic cross-sectional view of the printing apparatus 100 for explaining an example of the configuration of the transport unit 4.

As shown in FIG. 3, the transport unit 4 supplies the print paper PP to the printing unit 2 by transporting the print paper PP stored in the storage cassette 91 along a supply path Rt1. Next, the transport unit 4 transports the print paper PP along a printing path RtP provided in the printing unit 2. Then, the printing unit 2 forms the print image EP on the print paper PP transported on the printing path RtP. Specifically, the printing unit 2 includes a head unit 20 that ejects ink, and the head unit 20 ejects ink onto the print paper PP transported on the printing path RtP, thereby forming the print image EP on the print paper PP. After that, the transport unit 4 transports the print paper PP on which the print image EP is formed along a discharge path Rt2, thereby discharging the print paper PP to the discharge tray 401.

A plurality of transport roller pairs including a transport roller pair 411, a transport roller pair 412, and a transport roller pair 413 is provided on the supply path Rt1. The print paper PP stored in the storage cassette 91 is transported to the printing path RtP by a plurality of transport roller pairs provided on the supply path Rt1.

The printing path RtP is a path along which the print paper PP is transported when the printing unit 2 forms the print image EP on the print paper PP, and that is defined by a transport belt 44. Here, the transport belt 44 is an endless belt that rotates between a driving pulley 42 and a driven pulley 43. Specifically, the transport belt 44 is rotationally driven by the driving pulley 42 so that the upper portion, of the transport belt 44, positioned in the Z1 direction of the driving pulley 42 and the driven pulley 43 moves in the X2 direction as indicated by an arrow MV1 in FIG. 3, and the lower portion, of the transport belt 44, positioned in the Z2 direction of the driving pulley 42 and the driven pulley 43 moves in the Xl direction as indicated by an arrow MV2 in FIG. 3. In the present embodiment, the driving pulley 42 is provided at a position closer to the supply path Rt1 than the head unit 20 in the printing path RtP. A support plate 45 that supports the upper portion of the transport belt 44 is provided inside the transport belt 44.

As shown in FIG. 3, a charging roller 46 is provided in the vicinity of the printing path RtP so as to contact the outer face of the transport belt 44. In the present embodiment, the charging roller 46 is provided at a position closer to the supply path Rt1 than the position facing the head unit 20 in the printing path RtP. Specifically, in the present embodiment, the charging roller 46 is provided so that the transport belt 44 is pinched between the driving pulley 42 and the charging roller 46.

The charging roller 46 is charged by the power supply unit 5 and supplies the transport belt 44 with a charge of a predetermined polarity. When the print paper PP is transported by the transport belt 44, the print paper PP is attracted to the transport belt 44 by the charge of a predetermined polarity charged on the transport belt 44. A static elimination brush 47 is provided between the driving pulley 42 and the head unit 20 in the printing path RtP in order to remove the charge charged on a face, of the print paper PP transported along the printing path RtP, opposite to a face in contact with the transport belt 44.

A plurality of transport roller pairs including a transport roller pair 414, a transport roller pair 415, and a transport roller pair 416 is provided on the discharge path Rt2. The print paper PP transported through the printing path RtP is discharged to the discharge tray 401 by a plurality of transport roller pairs provided on the discharge path Rt2.

### 2. Display Configuration

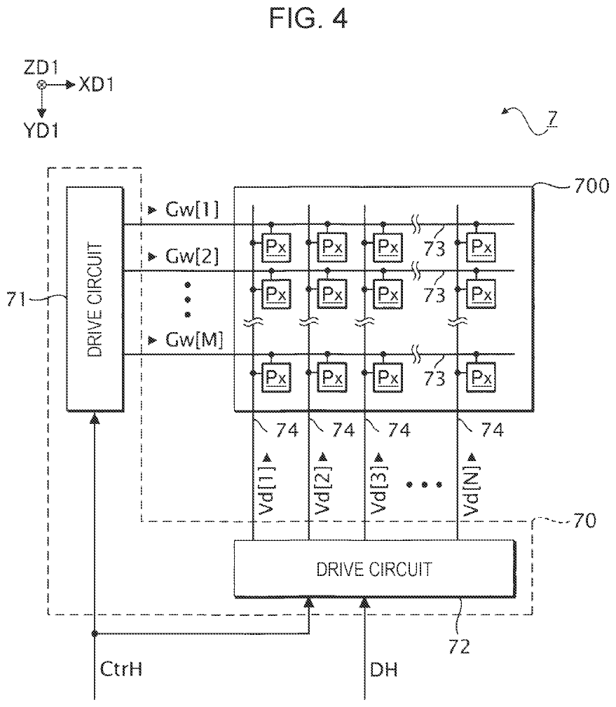

Hereinafter, an overview of the configuration of the display 7 according to the present embodiment will be described with reference to FIG. 4.

FIG. 4 is a block diagram showing an example of the configuration of the display 7.

As shown in FIG. 4, the display 7 includes a display region 700 including a plurality of pixels Px, and a drive circuit 70 that drives the display region 700.

The display region 700 includes M rows of scanning lines 73 extending in the XD1 direction, N columns of data lines 74 extending in the YD1 direction intersecting the XD1 direction, and (M×N) pixels Px corresponding to (M×N) intersections of M rows of scanning lines 73 and N columns of data lines 74 and disposed in a matrix of M rows in the YD1 direction and N columns in the XD1 direction. Here, the value M is a natural number that satisfies M≥2, and the value N is a natural number that satisfies N≥2.

Further, hereinafter, the XD1 direction and the XD2 direction opposite to the XD1 direction are collectively referred to as the XD axis direction, and the YD1 direction and the YD2 direction opposite to the YD1 direction are collectively referred to as the YD axis direction, and the ZD1 direction intersecting the axial direction and the YD axis direction and the ZD2 direction opposite to the ZD1 direction are collectively referred to as the ZD axis direction. In the present embodiment, the ZD1 direction is a direction toward the display region 700 from the user of the printing apparatus 100, for example. In the present embodiment, as an example, an explanation will be given assuming that the XD axis, YD axis, and ZD axis are orthogonal to each other. However, the present disclosure is not limited to such an embodiment. The XD axis, YD axis, and ZD axis are only required to intersect with each other.

The drive circuit 70 includes a drive circuit 71 and a drive circuit 72. The drive circuit 71 is supplied with a control signal CtrH for controlling the drive circuit 70 from the display controller 17. The drive circuit 72 is supplied with the control signal CtrH for controlling the drive circuit 70 and display information DH indicating the display screen EH to be displayed in the display region 700 from the display controller 17.

The drive circuit 71 generates a selection signal Gw[m] for selecting the m-th row scanning line 73 based on the control signal CtrH. Then, the drive circuit 71 sets a signal level of the selection signal Gw[m] to a predetermined signal level for selecting the m-th row scanning line 73 in the m-th selection period among the M selection periods included in the unit display period defined by the control signal CtrH. Thus, the drive circuit 71 can sequentially select the scanning lines 73 of the first row to the M-th row in the unit display period. Here, the variable m is a natural number that satisfies 1≤m≤M.

The drive circuit 72 generates a gradation designation signal Vd[n] that designates the gradation to be displayed in the pixel Px based on display information DH, and outputs the generated gradation designation signal Vd[n] to the n-th column data line 74 at the timing determined based on the control signal CtrH. Specifically, the drive circuit 72 outputs a gradation designation signal Vd[n] to the n-th column data line 74 in each of M selection periods during which the drive circuit 71 selects the scanning lines 73 of the first to M-th rows. Here, the variable n is a natural number that satisfies 1≤n≤N. Further, the display information DH may be signals including gradation designation signals Vd[1] to Vd[N].

In this way, the drive circuit 70 outputs the selection signal Gw[m] for selecting the m-th row scanning line 73 in the m-th selection period, and outputs the gradation designation signal Vd[n] to the n-th column data line 74, so that it is possible to display the gradation designated by the gradation designation signal Vd[n] on the pixel Px of the m-th row and the n-th column. As a result, the display 7 can display the display screen EH in the display region 700 in a unit display period consisting of M selection periods.

### 3. Overview of Touch Panel

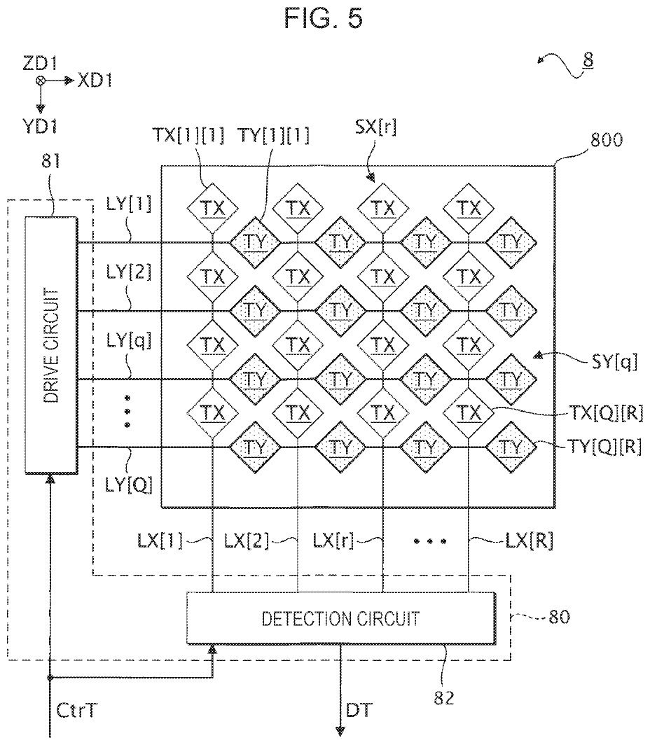

An overview of the touch panel 8 according to the present embodiment will be described below with reference to FIGS. 5 to 12.

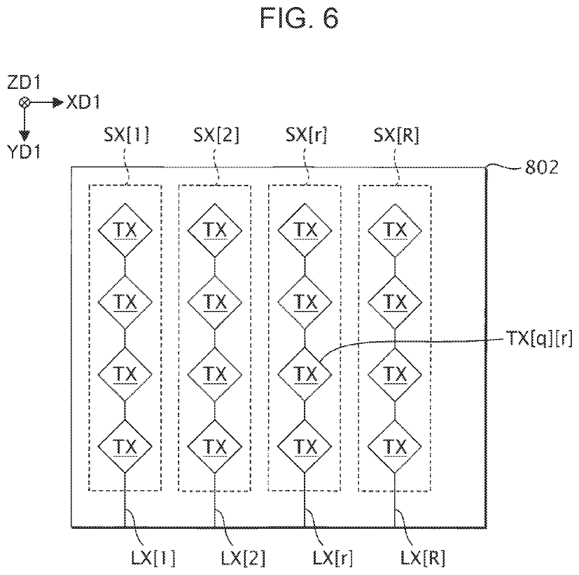

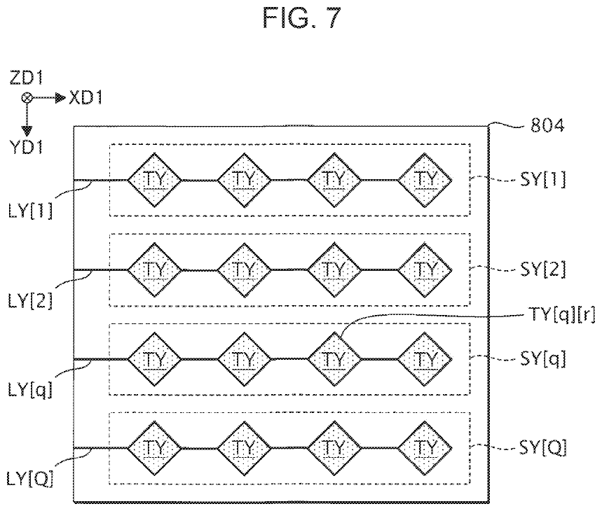

FIG. 5 is a block diagram showing an example of the configuration of the touch panel 8. FIG. 6 is a block diagram showing an example of the configuration of a detection electrode layer 802 provided on the touch panel 8. FIG. 7 is a block diagram showing an example of the configuration of a drive electrode layer 804 provided in the touch panel 8.

As shown in FIG. 5, the touch panel 8 includes a detection region 800 for detecting a touch by the user of the printing apparatus 100 and a detection control circuit 80 for identifying the user's touch position in the detection region 800.

As shown in FIGS. 5 to 7, the detection region 800 includes the detection electrode layer 802 having R columns of detection electrodes SX[1] to SX[R] disposed in the XD1 direction, and the drive electrode layer 804 having Q rows of drive electrodes SY[1] to SY[Q] disposed in the YD1 direction. Here, the value Q and the value R are natural numbers satisfying Q≥2 and R≥2. The R columns of detection electrodes SX[1] to SX[R] are provided so as to intersect the Q rows of drive electrodes SY[1] to SY[Q] when the detection region 800 is viewed in the ZD1 direction.

Hereinafter, among the R columns of detection electrodes SX[1] to SX[R], the r-th column detection electrode SX is referred to as a detection electrode SX[r]. Further, hereinafter, among the Q rows of drive electrodes SY[1] to SY[Q], the q-th drive electrode SY is referred to as a drive electrode SY[q]. Here, the variable q is a natural number that satisfies 1≤q≤Q, and the variable r is a natural number that satisfies 1≤r≤R.

In the present embodiment, the detection electrodes SX[r] and the drive electrodes SY[q] are made of a light-transmissive conductive material such as ITO. Here, ITO is an abbreviation for Indium Tin Oxide. Further, in the present embodiment, a portion, of the detection electrode layer 802, where the detection electrode SX[r] is not provided and a portion, of the drive electrode layer 804, where the drive electrode SY[q] is not provided are made of a light-transmissive insulating material.

As shown in FIG. 6, the detection electrode SX[r] includes Q electrodes TX disposed in the YD1 direction and wiring LX electrically coupling the Q electrodes TX. Hereinafter, among the Q electrodes TX provided in the detection electrode SX[r], the q-th electrode TX is referred to as an electrode TX[q][r]. Further, the wiring LX provided for the detection electrode SX[r] is hereinafter referred to as wiring LX[r]. Thus, in the present embodiment, as an example, it is assumed that the detection electrode SX[r] includes Q electrodes TX[1] [r] to TX[Q] [r]. However, the present disclosure is not limited to such an embodiment. The detection electrodes SX[r] may include one or more electrodes TX the number of which is different from Q.

As shown in FIG. 7, the drive electrode SY[q] includes R electrodes TY disposed in the XD1 direction and wiring LY electrically coupling the R electrodes TY. Note that the r-th electrode TY among the R electrodes TY provided in the drive electrode SY[q] is hereinafter referred to as an electrode TY[q][r]. Further, the wiring LY provided for the drive electrode SY[q] is hereinafter referred to as wiring LY[q]. Thus, in the present embodiment, as an example, it is assumed that the drive electrode SY[q] includes R electrodes TY[q] [1] to TX[q] [R], but the present disclosure is not limited to such an embodiment. The drive electrodes SY[q] may include one or more electrodes TY the number of which is different from R.

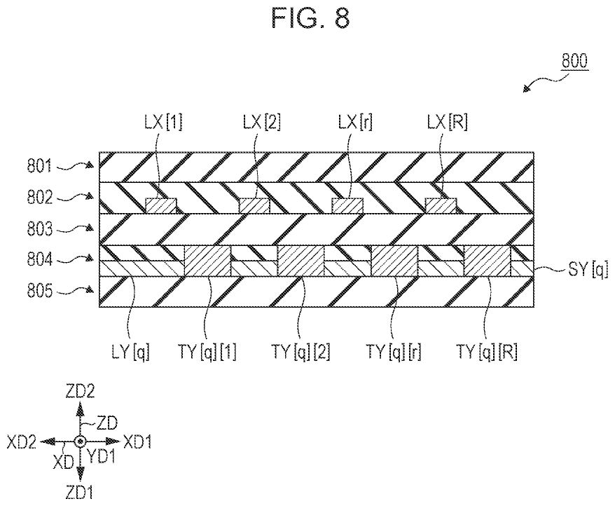

FIG. 8 is a cross-sectional view showing an example of the configuration of the touch panel 8. FIG. 8 shows a cross section of the detection region 800 when the detection region 800 is cut by a plane whose normal direction is the YD1 direction in FIG. 5 and which passes through the drive wiring SY[q].

As shown in FIG. 8, the detection region 800 includes a protective layer 801, the detection electrode layer 802, an insulating layer 803, the drive electrode layer 804, and a protective layer 805.

Among them, the protective layer 801 is made of a light-transmissive insulating material. The user of the printing apparatus 100 inputs a command to the touch panel 8 by touching the surface of the protective layer 801 in the ZD2 direction.

Moreover, the protective layer 805 is provided in the ZD1 direction relative to the protective layer 801 and is made of a light-transmissive insulating material. The insulating layer 803 is provided between the protective layer 801 and the protective layer 805 and is made of a light-transmissive insulating material.

Also, the detection electrode layer 802 is provided between the protective layer 801 and the insulating layer 803. As described above, the detection electrode layer 802 includes the detection electrode SX[r] including a plurality of electrodes TX[1] [r] to TX[Q] [r] and the wiring LX[r] physically coupling the electrodes TX[1][r] to TX[Q][r].

Also, the drive electrode layer 804 is provided between the insulating layer 803 and the protective layer 805. As described above, the drive electrode layer 804 includes the drive electrode SY[q] including a plurality of electrodes TY[q][1] to TX[q] [R] and the wiring LY[q] physically coupling the electrodes TY[q][1] to TX[q] [R].

In the present embodiment, the drive electrode layer 804 is positioned in the ZD1 direction when viewed from the detection electrode layer 802, but the present disclosure is not limited to such an embodiment. The drive electrode layer 804 may be provided in the ZD2 direction when viewed from the detection electrode layer 802. In this case, the drive electrode layer 804 may be provided between the protective layer 801 and the insulating layer 803 and the detection electrode layer 802 may be provided between the protective layer 805 and the insulating layer 803.

The description is returned to FIG. 5. As shown in FIG. 5, the detection control circuit 80 includes a drive circuit 81 and a detection circuit 82. The drive circuit 81 and the detection circuit 82 are supplied with a control signal CtrT for controlling the detection control circuit 80 from the panel controller 18. Here, the control signal CtrT is signals including a vertical synchronizing signal Vsnc, a vertical clock signal CLy, a horizontal synchronizing signal Hsnc, a horizontal clock signal CLx, and a mode designation signal SigM. Among them, the mode designation signal SigM is a signal indicating a control mode designated by the mode determination unit 19. Further, the detection circuit 82 outputs a touch detection signal DT indicating the detection result of the user's touch on the detection region 800.

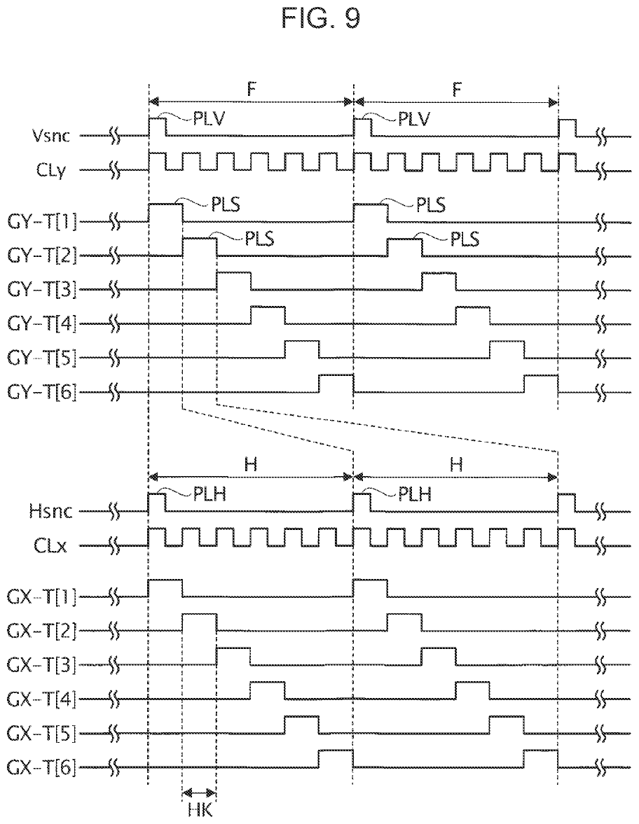

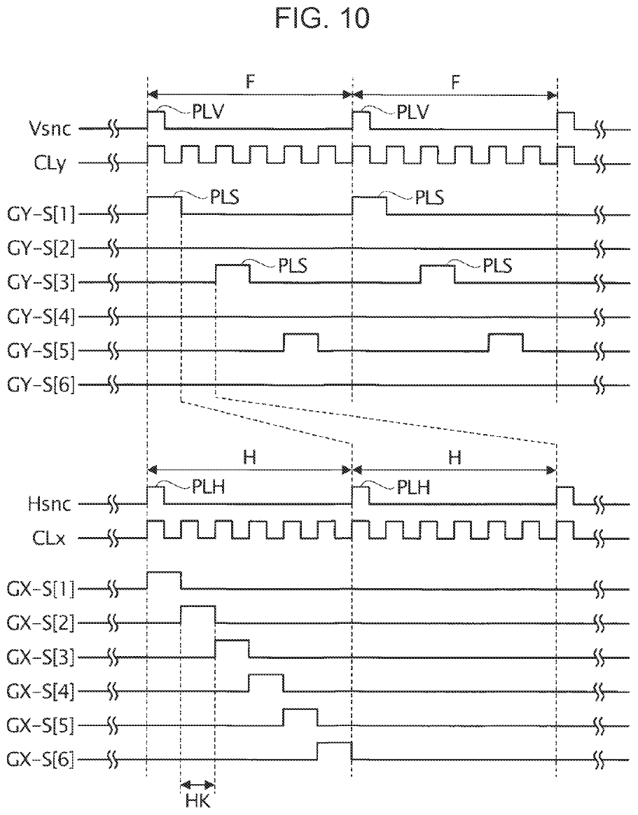

FIGS. 9 and 10 are timing charts for explaining the control signal CtrT and the operation of the detection control circuit 80. FIG. 9 shows the operation of the detection control circuit 80 in the normal operation mode. FIG. 10 also shows the operation of the detection control circuit 80 in the sleep mode. The detection control circuit 80 operates in a manner in accordance with the control mode indicated by the mode designation signal SigM. Specifically, the detection control circuit 80 operates in a manner in accordance with the normal operation mode when the mode designation signal SigM indicates the normal operation mode, and operates in a manner in accordance with the sleep mode when the mode designation signal SigM indicates the sleep mode.

As shown in FIGS. 9 and 10, the vertical synchronizing signal Vsnc is a signal including a pulse PLV, and defines a frame period F as a period from the rise of the pulse PLV to the rise of the next pulse PLV. In the present embodiment, as an example, it is assumed that the frame period F is composed of Q horizontal scanning periods H. Then, hereinafter, among the Q horizontal scanning periods H that composes the frame period F, the q-th horizontal scanning period H is referred to as a horizontal scanning period H[q]. FIGS. 9 and 10 show the case of “Q=6”

The horizontal synchronizing signal Hsnc is a signal including a pulse PLH, and defines a horizontal scanning period H as a period from the rise of the pulse PLH to the rise of the next pulse PLH. In the present embodiment, it is assumed that the horizontal scanning period H is composed of R detection periods HK. Then, hereinafter, among the R detection periods HK that composes the horizontal scanning period H, the r-th detection period HK is referred to as a detection period HK[r]. FIGS. 9 and 10 show the case of “R=6”.

The vertical clock signal CLy is a signal having pulses with the horizontal scanning period H as a cycle. The drive circuit 81 generates Q selection signals GY[1] to GY[Q] corresponding to Q drive electrodes SY[1] to SY[Q] in a one-to-one correspondence based on the vertical clock signal CLy.

Hereinafter, among the Q selection signals GY[1] to GY[Q], the q-th selection signal GY is referred to as a selection signal GY[q]. The selection signal GY[q] generated by the drive circuit 81 in the normal operation mode is referred to as a normal time selection signal GY-T[q], and the selection signal GY[q] generated by the drive circuit 81 in the sleep mode is referred to as a sleep time selection signal GY-S[q]. In the following description, the variable q1 is a positive odd number satisfying 1≤q1≤Q, the variable q2 is a positive even number satisfying 2≤q2≤Q, the variable r1 is a positive odd number satisfying 1≤r1≤R, and the variable r2 be a positive even number that satisfies 2≤r2≤R. In the following description, the number of odd numbers q1 satisfying 1≤q1≤Q is defined as Q1, the number of even numbers q2 satisfying 1≤q2≤Q is defined as Q2, the number of odd numbers r1 satisfying 1≤r1≤R is defined as R1, and the number of even numbers r2 satisfying 1≤r2≤R is defined as R2.

As shown in FIG. 9, the normal time selection signal GY-T[q] has a drive pulse PLS that rises from a low level to a high level and then falls again to a low level in the horizontal scanning period H[q] of the frame period F. In addition, the normal time selection signal GY-T[q] maintains the low level during a period other than the horizontal scanning period H[q] of the frame period F.

As shown in FIG. 10, a sleep time selection signal GY-S[q1] has the drive pulse PLS in the horizontal scanning period H[q] of the frame period F. Further, the sleep time selection signal GY-S[q1] maintains the low level during a period other than the horizontal scanning period H[q] of the frame period F. In addition, the sleep time selection signal GY-S[q2] maintains the low level during the frame period F.

The horizontal clock signal CLx is a signal having pulses with a cycle of the detection period HK. The detection circuit 82 generates R selection signals GX[1] to GX[R] corresponding to the R detection electrodes SX[1] to SX[R] in a one-to-one correspondence based on the horizontal clock signal CLx.

Hereinafter, among the R selection signals GX[1] to GX[R], the r-th selection signal GX is referred to as a selection signal GX[r]. The selection signal GX[r] generated by the detection circuit 82 in the normal operation mode is referred to as a normal time selection signal GX-T[r], and the selection signal GX[r] generated by the detection circuit 82 in the sleep mode is referred to as a sleep time selection signal GX-S[r].

As shown in FIG. 9, the normal time selection signal GX-T[r] maintains the high level during the detection period HK[r] of the horizontal scanning period H[q], and maintains the low level during a period other than detection period HK[r] of the horizontal scanning period H[q].

As shown in FIG. 10, the sleep time selection signal GX-S[r] maintains the high level during the detection period HK[r] of the horizontal scanning period H[q1], maintains the low level during a period other than the detection period HK[r] of the horizontal scanning period H[q1], and maintains the low level during the horizontal scanning period H[q2].

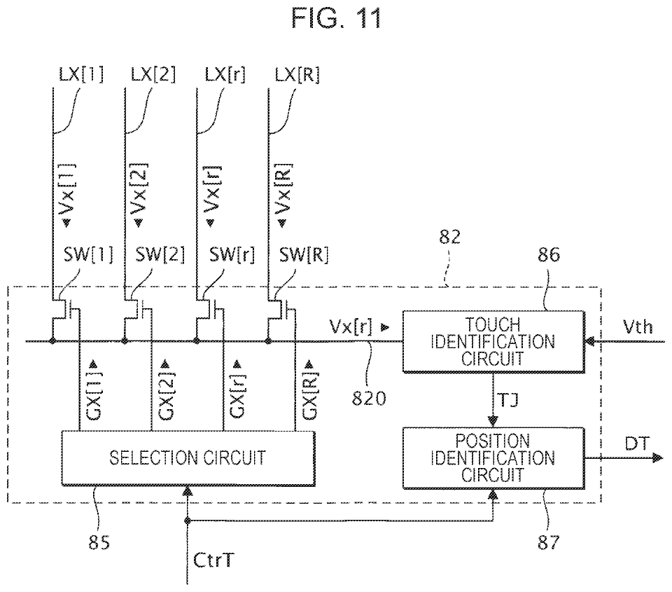

FIG. 11 is a block diagram showing an example of the configuration of the detection circuit 82.

As shown in FIG. 11, the detection circuit 82 includes R switches SW[1] to SW[R] corresponding to R columns of wirings LX[1] to LX[R] in a one-to-one correspondence, a selection circuit 85 that selects the wiring LX[r] from among the R columns of wirings LX[1] to LX[R] by controlling ON/OFF of each of the R switches SW[1] to SW[R], a touch identification circuit 86 that identifies whether the user touches the detection region 800, and a position identification circuit 87 that identifies the user's touch position on the detection region 800.

The switch SW[r] switches ON/OFF between the wiring LX[r] and wiring 820 electrically coupled to the touch identification circuit 86. When the switch SW[r] is turned on, a detection signal Vx[r] is supplied from the wiring LX[r] to the touch identification circuit 86 via the switch SW[r] and the wiring 820. Here, the detection signal Vx[r] is a signal indicating the potential of the wiring LX[r].

The selection circuit 85 outputs a selection signal GX[r] to the switch SW[r]. In the present embodiment, it is assumed that the switch SW[r] is turned on when the selection signal GX[r] is at high level, and the switch SW[r] is turned off when the selection signal GX[r] is at low level.

The touch identification circuit 86 identifies whether the user touches the detection region 800 based on the detection signal Vx[r] supplied via the wiring 820 and a threshold value signal Vth supplied from the power supply unit 5. Then, the touch identification circuit 86 outputs a touch identification signal TJ indicating the result of the identification.

The position identification circuit 87 identifies whether the user touches a position Pos[q][r] corresponding to the detection electrode SX[r] and the drive electrode SY[q] based on the touch identification signal TJ and the control signal CtrT. Specifically, in a case where the timing identified by the horizontal synchronizing signal Hsnc or the vertical clock signal CLy of the control signal CtrT is a timing at which the drive circuit 81 sets the drive pulse PLS for the selection signal GY[q] and the drive electrode SY[q] is selected, and the timing identified by the horizontal clock signal CLx of the control signal CtrT is a timing at which the detection circuit 82 sets the selection signal GX[r] to a high level and the detection electrode SX[r] is selected, when the touch identification signal TJ indicates that the detection region 800 is touched by the user, the position identification circuit 87 outputs the touch detection signal DT indicating that the position Pos[q][r] is touched by the user.

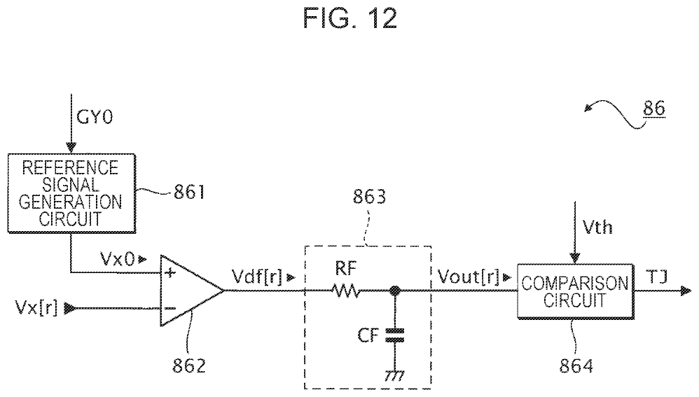

FIG. 12 is a block diagram showing an example of the configuration of the touch identification circuit 86.

As shown in FIG. 12, the touch identification circuit 86 includes a reference signal generation circuit 861, a subtraction circuit 862, a filter circuit 863, and a comparison circuit 864.

The reference signal generation circuit 861 generates a reference detection signal Vx0 based on a selection signal GY0 having the drive pulse PLS. Here, the reference detection signal Vx0 is a signal having a waveform substantially same as a waveform that indicates the potential fluctuation of the detection electrode SX[r] when the selection signal GY[q] having the drive pulse PLS is supplied to the wiring LY[q] of the drive electrode SY[q], and there is no user touch in the vicinity of the intersection of the detection electrode SX[r] and the drive electrode SY[q]. That is, the reference detection signal Vx0 is the detection signal Vx[r] detected from the detection electrode SX[r] when the selection signal GY[q] having the drive pulse PLS is supplied to the drive electrode SY[q], and there is no user touch on the position Pos[q][r]. Here, “substantially same” is a concept that includes not only “completely same”, but also “considered to be the same when an error is taken into account”. For example, “substantially same” may be a concept that includes “can be regarded to be the same when removing an error of 10% or less”.

The subtraction circuit 862 outputs a difference signal Vdf[r] indicating the difference between the reference detection signal Vx0 and the detection signal Vx[r] based on the reference detection signal Vx0 and the detection signal Vx[r].

As described above, when the detection region 800 is viewed in the ZD1 direction, the detection electrodes SX[r] and the drive electrodes SY[q] intersect. Therefore, a capacitance is formed between the detection electrode SX[r] and the drive electrode SY[q]. For example, a capacitance is formed between the electrode TX[q][r] of the detection electrode SX[r] and the electrode TY[q][r] of the drive electrode SY[q]. Therefore, when the selection signal GY[q] having the drive pulse PLS is supplied to the wiring LY[q] of the drive electrode SY[q], the potential of the detection electrode SX[r] also fluctuates via the capacitance formed between the detection electrode SX[r] and the drive electrode SY[q]. Then, when the finger or the like of the user of the printing apparatus 100 is touched in the vicinity of the intersection of the detection electrode SX[r] and the drive electrode SY[q], a capacitance is formed between the user's finger or the like and the detection electrode SX[r] or the drive electrode SY[q]. Therefore, a mode of a change in the potential of the detection electrode SX[r] when the selection signal GY[q] having the drive pulse PLS is supplied to the wiring LY[q] of the drive electrode SY[q], and the user touches the vicinity of the intersection of the detection electrode SX[r] and the drive electrode SY[q] is different from a mode of a change in the potential of the detection electrode SX[r] when the selection signal GY[q] having the drive pulse PLS is supplied to the wiring LY[q] and there is no user touch in the vicinity of the intersection of the detection electrode SX[r] and the drive electrode SY[q]. That is, a waveform of the detection signal Vx[r] when the selection signal GY[q] having the drive pulse PLS is supplied to the drive electrode SY[q] and the user touches the position Pos[q][r] is different from a waveform of the reference detection signal Vx0. On the other hand, a waveform of the detection signal Vx[r] when the selection signal GY[q] having the drive pulse PLS is supplied to the drive electrode SY[q] and the position Pos[q][r] is not touched by the user is substantially the same as a waveform of the reference detection signal Vx0.

The filter circuit 863 includes a resistor RF having one end electrically coupled to the output end of the subtraction circuit 862 and the other end electrically coupled to the input end of the comparison circuit 864, and a capacitor CF having one electrode electrically coupled to the other end of the resistor RF, and the other electrode electrically coupled to the wiring set to the ground potential. The filter circuit 863 functions as a low-pass filter that outputs low-frequency components below the cutoff frequency in the difference signal Vdf[r] as an output signal Vout[r]. In the present embodiment, as an example, it is assumed that the degree of difference between the shape of the waveform of the detection signal Vx[r] and the shape of the waveform of the reference detection signal Vx0 when the potential of the output signal Vout[r] is high is larger than that when the potential is low. The reference detection signal Vx0 is an example of a “reference signal”, and the output signal Vout[r] is an example of a “comparison signal”.

The comparison circuit 864 compares the potential of the output signal Vout[r] and the potential of the threshold value signal Vth. In the present embodiment, the threshold value signal Vth is set to a threshold value potential Vth1 in the normal operation mode, and set to a threshold value potential Vth2 in the sleep mode. Here, the threshold value potential Vth1 and the threshold value potential Vth2 satisfy “0≤Vth2≤Vth1”. The threshold value potential Vth1 is an example of a “first threshold value potential”, and the threshold value potential Vth2 is an example of a “second threshold value potential”.

Then, in the normal operation mode, the comparison circuit 864 generates the touch identification signal TJ indicating that the detection region 800 is touched by the user when the potential of the output signal Vout[r] is equal to or higher than the threshold value potential Vth1 indicated by the threshold value signal Vth. In addition, in the normal operation mode, the comparison circuit 864 generates the touch identification signal TJ indicating that the detection region 800 is not touched by the user when the potential of the output signal Vout[r] is less than the threshold value potential Vth1 indicated by the threshold value signal Vth. On the other hand, in the sleep mode, the comparison circuit 864 generates the touch identification signal TJ indicating that the detection region 800 is touched by the user when the potential of the output signal Vout[r] is equal to or higher than the threshold value potential Vth2 indicated by the threshold value signal Vth. Further, in the sleep mode, the comparison circuit 864 generates the touch identification signal TJ indicating that the detection region 800 is not touched by the user when the potential of the output signal Vout[r] is less than the threshold value potential Vth2 indicated by the threshold value signal Vth.

As described above, according to the present embodiment, in the normal operation mode, the drive circuit 81 generates the Q selection signals GY-T each having the drive pulse PLS, thereby selecting all of Q rows of wirings LY to drive all of the Q rows of drive electrodes SY. Further, according to the present embodiment, in the sleep mode, the drive circuit 81 generates Q1 sleep time selection signals GY-S each having the drive pulse PLS, thereby selecting only Q1 rows of wirings LY from among the Q rows of wirings LY and driving only the Q1 rows of drive electrodes SY among the Q rows of drive electrodes SY. For this reason, according to the present embodiment, it is possible to reduce the possibility that ink that floats inside the printing apparatus 100 in mist after being ejected from the head unit 20 is attached to the detection region 800, compared with a mode in which all of the Q rows of drive electrodes SY are driven in the sleep mode. In other words, according to the present embodiment, it is possible to reduce the possibility that the touch panel 8 will malfunction due to ink that floats inside the printing apparatus 100 in mist after being ejected from the head unit 20, compared with a mode in which all the Q rows of drive electrodes SY are driven in the sleep mode.

Further, according to the present embodiment, the drive circuit 81 drives only the Q1 rows of drive electrodes SY among the Q rows of drive electrodes SY in the sleep mode, so that the power required to drive the drive electrodes SY is smaller than that in the normal operation mode in which all the Q rows of drive electrodes SY are driven. Therefore, in the present embodiment, the power supply unit 5 makes the amount of power supplied to the touch panel 8 in the sleep mode smaller than the amount of power supplied to the touch panel 8 in the normal operation mode. That is, according to the present embodiment, power consumption of the printing apparatus 100 can be suppressed, compared with a mode in which the amount of power supplied to the touch panel 8 in the sleep mode is equal to the amount of power supplied to the touch panel 8 in the normal operation mode.

Further, according to the present embodiment, the power supply unit 5 sets, in the normal operation mode, the potential of the threshold value signal Vth to the threshold value potential Vth1, and sets, in the sleep mode, the potential of the threshold value signal Vth to a threshold value potential Vth2 that is a potential lower than the threshold value potential Vth1. Therefore, according to the present embodiment, power consumption of the printing apparatus 100 can be suppressed, compared with a mode in which the potential of the threshold value signal Vth is set to the threshold value potential Vth1 in the sleep mode.

Note that in the present embodiment, the detection circuit 82 identifies the user's touch position on the detection region 800 even in the sleep mode. However, the present disclosure is not limited to such an embodiment. In the sleep mode, the detection circuit 82 may only identify whether the user touches the detection region 800 without identifying the user's touch position on the detection region 800. In this case, the panel controller 18 does not have to supply the control signal CtrT to the position identification circuit 87 in the sleep mode.

In the present embodiment, each of the wiring LX[r] and the wiring LY[q] is an example of a “pattern wiring”, the detection control circuit 80 is an example of a “identification circuit”, the selection signal GY having the drive pulse PLS is an example of a “drive signal”, the wiring LY to which the selection signal GY having the drive pulse PLS is supplied is an example of a “drive wiring”, the number Q of wirings LY selected as the drive wirings in the normal operation mode is an example of a “first reference number”, and the number Q1 of wirings LY selected as the drive wirings in the sleep mode is an example of a “second reference number”.

### 4. Conclusion of Embodiments

As described above, the printing apparatus 100 according to the present embodiment includes the display 7 that displays information to the user, the capacitive touch panel 8 that receives an instruction from the user, the transport unit 4 that transports the print paper PP, the printing unit 2 that forms the print image EP by applying a color material to the print paper PP, the power supply unit 5 that supplies power to the display 7, the touch panel 8, the transport unit 4, and the printing unit 2, and the control unit 1 that controls the display 7, the touch panel 8, the transport unit 4, the printing unit 2, and the power supply unit 5, wherein the control unit 1 is configured to control a normal operation mode in which the power supply unit 5 is controlled so that power is supplied from the power supply unit 5 to the display 7, the touch panel 8, the transport unit 4, and the printing unit 2, and a sleep mode in which the power supply unit 5 is controlled so that a power supply from the power supply unit 5 to the display 7, the transport unit 4, and the printing unit 2 is restricted, and power is supplied from the power supply unit 5 to the touch panel 8, and wherein an amount of power supplied from the power supply unit 5 to the touch panel 8 in the sleep mode is smaller than an amount of power supplied from the power supply unit 5 to the touch panel 8 in the normal operation mode.

Therefore, according to the present embodiment, it is possible to reduce the possibility that the color material is attached to the touch panel 8 in the sleep mode, compared with a mode in which the same power as in the normal operation mode is supplied to the touch panel 8 even in the sleep mode. Therefore, according to the present embodiment, it is possible to reduce the possibility that the touch panel 8 will malfunction due to the color material attached to the touch panel 8.

Further, in the printing apparatus 100 according to the present embodiment, the touch panel 8 may include the Q rows of wirings LY and the R columns of wirings LX, may identify a touch position on the touch panel 8 based on the detection signal Vx[r] detected from the wiring LX[r] when each of the Q rows of wirings LY is selected as a drive wiring, and the selection signal GY having the drive pulse PLS is supplied to each of the Q rows of wirings LY in the normal operation mode, and may identify whether the touch panel 8 is touched based on the detection signal Vx[r] detected from the wiring LX[r] when each of the Q1 rows of wirings LY the number of which is fewer than Q rows is selected as a drive wiring, and the selection signal GY having the drive pulse PLS is supplied to each of the Q1 rows of wirings LY in the sleep mode.

Therefore, according to the present embodiment, power consumption of the printing apparatus 100 can be suppressed, compared with a mode in which each of the Q rows of wirings LY is selected as a drive wiring in the sleep mode.

Further, in the printing apparatus 100 according to the present embodiment, the touch panel 8 may include the detection region 800 including the Q rows of wirings LY and the R columns of wirings LX, and the detection control circuit 80 that identifies whether the touch panel 8 is touched based on the detection signal Vx[r] detected from the wiring LX[r] among the R columns of wirings LX, wherein the detection control circuit 80 may generate the output signal Vout[r] indicating a potential according to the degree of difference between a waveform of the detection signal Vx[r] and a waveform of the reference detection signal Vx0 having a waveform detected from the wiring LX[r] when the touch panel 8 is not touched, wherein the detection control circuit 80 may identify, in the normal operation mode, a touch on the touch panel 8 when the potential indicated by the output signal Vout[r] is equal to or higher than the threshold value potential Vth1, and wherein the detection control circuit 80 may identify, in the sleep mode, a touch on the touch panel 8 when the potential indicated by the output signal Vout[r] is equal to or higher than the threshold value potential Vth2 that is lower than the threshold value potential Vth1.

Therefore, according to the present embodiment, power consumption of the printing apparatus 100 can be suppressed, compared with a mode in which a signal having the threshold value potential Vth1 is supplied to the detection control circuit 80 even in the sleep mode.

### B. Modifications

The above embodiment can be variously modified. Specific modifications are exemplified below. Two or more modes optionally selected from the following exemplifications can be appropriately merged within a range not inconsistent with each other. In the modifications illustrated below, elements having the same actions and functions as those of the embodiments will be denoted by the reference numerals used in the above description, and detailed description thereof will be appropriately omitted.

### First Modification

In the above-described embodiment, a case where the detection circuit 82 detects R detection signals Vx[1] to Vx[R] from the R columns of detection electrodes SX[1] to SX[R] provided in the detection region 800 in the sleep mode is described as an example, but the present disclosure is not limited to such an embodiment. For example, in the sleep mode, the detection circuit 82 may detect the detection signals Vx from some detection electrodes SX of the R columns of detection electrodes SX[1] to SX[R] provided in the detection region 800.

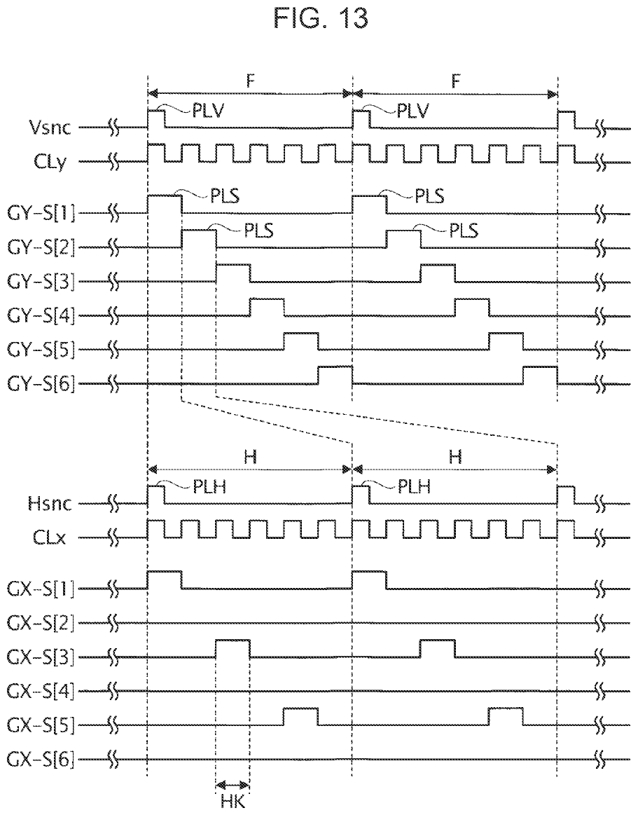

FIG. 13 is a timing chart for explaining the operation in the sleep mode of the detection control circuit 80 according to the modification. Note that the detection control circuit 80 according to the modification performs the same operation as the embodiment shown in FIG. 9 in the normal operation mode.

As shown in FIG. 13, in the sleep mode, the drive circuit 81 according to the present modification generates a sleep time selection signal GY-S[q] having the drive pulse PLS in the horizontal scanning period H[q] based on the vertical clock signal CLy. Further, in the sleep mode, the detection circuit 82 according to the present modification generates a sleep time selection signal GX-S[r1] and a sleep time selection signal GX-S[r2] based on the horizontal clock signal CLx. Here, the sleep time selection signal GX-S[r1] maintains the high level during the detection period HK[r1] of the horizontal scanning period H[q], and maintains the low level during a period other than the detection period HK[r1] of the horizontal scanning period H[q]. Also, the sleep time selection signal GX-S[r2] maintains the low level during the horizontal scanning period H[q].

As described above, in the printing apparatus 100 according to the present modification, the touch panel 8 may include the Q rows of wirings LY and the R columns of wirings LX, may identify, in the normal operation mode, a touch position on the touch panel 8 based on the detection signal Vx[r] detected from each of the R columns of wirings Lx, and may identify, in the sleep mode, whether the touch panel 8 is touched based on the detection signal Vx[r1] detected from each of R1 columns of wirings LX the number of which is fewer than R columns.

For this reason, according to the modification, power consumption of the printing apparatus 100 can be suppressed, compared with a mode in which the touch position on the touch panel 8 is identified based on the detection signal Vx[r] detected from each of R rows of wirings LX in the sleep mode.

Note that in the modification, the number R of the wirings LX for which the detection signal Vx[r] is detected in the normal operation mode is an example of a “first detection number”, and the number R1 of wirings LX for which the detection signal Vx[r1] is detected in the sleep mode is an example of a “second detection number”.

### Second Modification

In the above-described embodiment and the first modification, a case in which the drive circuit 81 selects some or all of the Q rows of drive electrodes SY[1] to SY[Q] in the sleep mode with a frame period F same as that in the normal operation mode as a cycle, but the present disclosure is not limited to such an embodiment. For example, the drive circuit 81 may select some or all of the Q rows of drive electrodes SY[1] to SY[Q] in the sleep mode with a period longer than that in the normal operation mode.

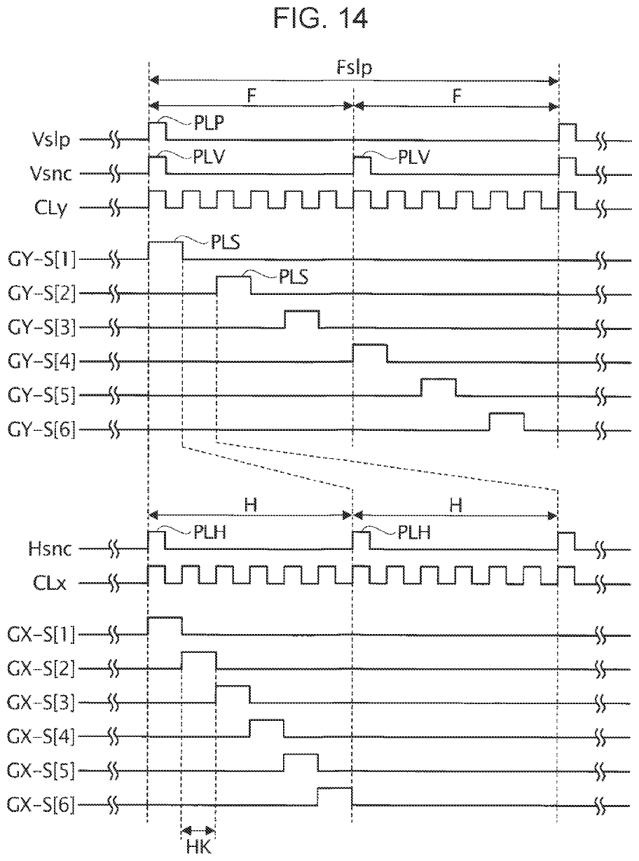

FIG. 14 is a timing chart for explaining the operation in the sleep mode of the detection control circuit 80 according to the modification and the control signal CtrT according to the modification. Note that the detection control circuit 80 according to the modification performs the same operation as the embodiment shown in FIG. 9 in the normal operation mode.

As shown in FIG. 14, in the modification, the control signal CtrT includes a sleep time synchronizing signal Vslp in addition to a vertical synchronizing signal Vsnc, a vertical clock signal CLy, a horizontal synchronizing signal Hsnc, a horizontal clock signal CLx, and a mode designation signal SigM.

The sleep time synchronizing signal Vslp is a signal including the pulse PLP, and defines an extended frame period Fslp as a period from the rise of the pulse PLP to the rise of the next pulse PLP. In the modification, it is assumed that the extended frame period Fslp is composed of (2*Q) horizontal scanning periods H, as an example. That is, in the modification, it is assumed that the extended frame period Fslp is composed of two frame periods F, as an example. However, the present disclosure is not limited to such an embodiment. The extended frame period Fslp is only required to be any period longer than the frame period F. Further, hereinafter, each of the (2*Q) horizontal scanning periods H composing the extended frame period Fslp will be referred to as a horizontal scanning period H[1], a horizontal scanning period H[2], . . . , a horizontal scanning period H[2q-1], a horizontal scanning period H[2q], . . . , a horizontal scanning period H[2Q-1], and a horizontal scanning period H[2Q].

As shown in FIG. 14, in the sleep mode, the drive circuit 81 according to the modification generates, based on the vertical clock signal CLy, the sleep time selection signal GY-S[q] that has the drive pulse PLS in the horizontal scanning period H[2q-1] of the extended frame period Fslp, and that maintains the low level during a period other than the horizontal scanning period H[2q-1] of the extended frame period Fslp. Further, in the sleep mode, the detection circuit 82 according to the present modification generates, based on the horizontal clock signal CLx and the vertical clock signal CLy, the sleep time selection signal GX-S[r] that maintains the high level during the detection period HK[r] of the horizontal scanning period H[2q-1], maintains the low level during a period other than the detection period HK[r] of the horizontal scanning period H[2q-1], and maintains the low level during the horizontal scanning period H[2q].

As described above, in the printing apparatus 100 according to the modification, the touch panel 8 may identify the touch position on the touch panel 8 for each frame period F in the normal operation mode, and may identify whether the touch panel 8 is touched for each extended frame period Fslp longer than the frame period F in the sleep mode.

Therefore, according to the modification, power consumption of the printing apparatus 100 can be suppressed, comparison with a mode in which whether the touch panel 8 is touched is identified for each frame period F in the sleep mode.

In the modification, the cycle repeated every frame period F is an example of a “first cycle”, and the cycle repeated every extended frame period Fslp is an example of a “second cycle”.

### Third Modification

In the above-described embodiment and the first modification and the second modification, the image forming apparatus such as the printing apparatus 100 is described as an example of the electronic device, but the present disclosure is not limited to such an embodiment. The present disclosure can be applied to any electronic device having the capacitive touch panel 8, such as a camera having the capacitive touch panel 8, a projector having the capacitive touch panel 8, and the like.

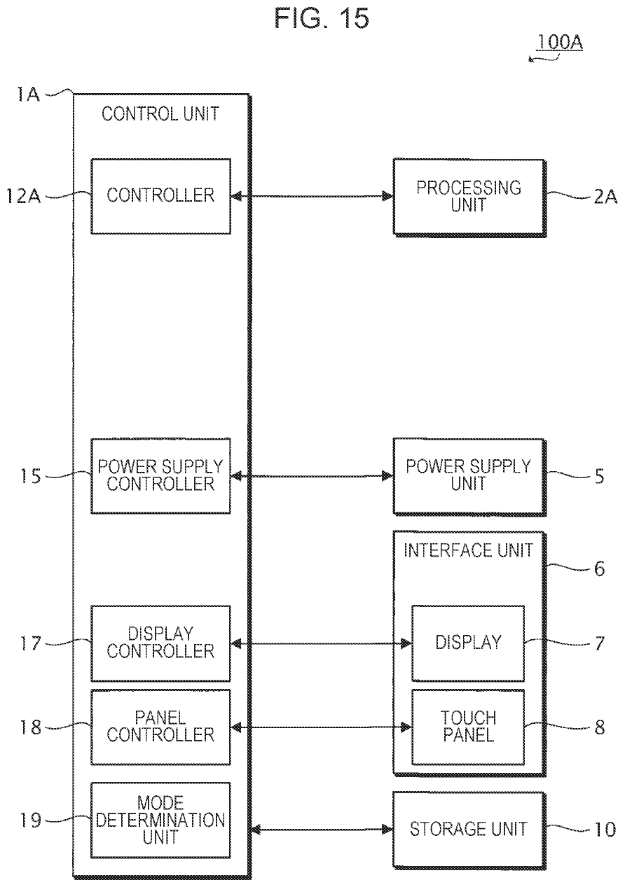

FIG. 15 is a functional block diagram showing an example of the functional configuration of an electronic device 100A according to the modification.

As shown in FIG. 15, the electronic device 100A includes a control unit 1A that controls the electronic device 100A, a processing unit 2A that executes various processes, the power supply unit 5 that supplies power to respective components of the electronic device 100A, the display 7 that displays various pieces of information to the user of the electronic device 100A, the interface unit 6 including the capacitive touch panel 8 that receives input of a command from the user of the electronic device 100A, and the storage unit 10 that stores various kinds of information such as a control program and the like for the electronic device 100A.

Here, the processing unit 2A is, for example, an imaging unit that performs an imaging process of imaging an object when the electronic device 100A is a camera, and is a projection unit that performs a projection process of projecting a desired image when the electronic device 100A is a projector.

Moreover, in the modification, the control unit 1A includes a processing circuit such as a CPU or an FPGA, and controls respective components of the electronic device 100A. Specifically, the processing circuit provided in the control unit 1A executes a control program, for the electronic device 100A, stored in the storage unit 10 and operates according to the control program, thereby being able to function as a unit controller 12A that controls the processing unit 2A, the power supply controller 15 that controls the power supply unit 5, the display controller 17 that controls the display 7, the panel controller 18 that controls the touch panel 8, and the mode determination unit 19 that determines a control mode in which the control unit 1A controls the electronic device 100A.

Also in the modification, as in the embodiment described above, the control unit 1A can control the electronic device 100A in a plurality of control modes including the normal operation mode and the sleep mode. Note that control of the electronic device 100A in the normal operation mode and control of the electronic device 100A in the sleep mode are the same as control of the printing apparatus 100 in the normal operation mode and control of the printing apparatus 100 in the sleep mode in the above-described embodiment and the first modification and the second modification, so that a description thereof will be omitted.

As described above, the electronic device 100A according to the present modification includes the display 7 that displays information to the user, the capacitive touch panel 8 that receives an instruction from the user, the power supply unit 5 that supplies power to the display 7 and the touch panel 8, and the control unit 1A that controls the display 7, the touch panel 8, and the power supply unit 5, wherein the control unit 1A is configured to control a normal operation mode in which the power supply unit 5 is controlled so that power is supplied from the power supply unit 5 to the display 7 and the touch panel 8 and a sleep mode in which the power supply unit 5 is controlled so that a power supply from the power supply unit 5 to the display 7 is restricted and power is supplied from the power supply unit 5 to the touch panel 8, wherein an amount of power supplied from the power supply unit 5 to the touch panel 8 in the sleep mode is smaller than an amount of power supplied from the power supply unit 5 to the touch panel 8 in the normal operation mode.

Therefore, according to the present embodiment, it is possible to reduce the possibility that dust is attached to the touch panel 8 in the sleep mode, compared with a mode in which the same power as in the normal operation mode is supplied to the touch panel 8 even in the sleep mode. Therefore, according to the present embodiment, it is possible to reduce the possibility that the touch panel 8 will malfunction due to dust attached to the touch panel 8.

What is claimed is:

1. An image forming apparatus comprising:
a display that displays information to a user;
a capacitive touch panel that receives an instruction from a user;
a transporter that transports a medium;
an image forming unit that forms an image by applying a color material to the medium;
a power supplier that supplies power to the display, the touch panel, the transporter, and the image forming unit; and
a controller that controls the display, the touch panel, the transporter, the image forming unit, and the power supplier, wherein
the controller is configured to control
a first mode in which the power supplier is controlled so that power is supplied from the power supplier to the display, the touch panel, the transporter, and the image forming unit, and
a second mode in which the power supplier is controlled so that a power supply from the power supplier to the display, the transporter, and the image forming unit is restricted, and power is supplied from the power supplier to the touch panel, and wherein
an amount of power supplied from the power supplier to the touch panel in the second mode is smaller than an amount of power supplied from the power supplier to the touch panel in the first mode.

2. The image forming apparatus according to claim 1, wherein
the touch panel includes a plurality of pattern wirings, wherein
the touch panel
identifies, in the first mode, a touch position on the touch panel based on a signal detected from a first detection number of pattern wirings among the plurality of pattern wirings, and
identifies, in the second mode, whether the touch panel is touched based on a signal detected from a second detection number of pattern wirings that is fewer than the first detection number among the plurality of pattern wirings.

3. The image forming apparatus according to claim 1, wherein
the touch panel includes a plurality of pattern wirings, wherein
the touch panel
identifies, in the first mode, a touch position on the touch panel based on a signal detected from a detection wiring different from the drive wirings among the plurality of pattern wirings
when each of a first reference number of pattern wirings among the plurality of pattern wirings is selected as a drive wiring, and
a drive signal is supplied to each of the first reference number of drive wirings, and
identifies, in the second mode, whether the touch panel is touched based on a signal detected from the detection wiring
when each of a second reference number of pattern wirings that is fewer than the first reference number among the plurality of pattern wirings is selected as a drive wiring, and
a drive signal is supplied to each of the second reference number of drive wirings.

4. The image forming apparatus according to claim 1, wherein
the touch panel
identifies, in the first mode, a touch position on the touch panel in a first cycle, and
identifies, in the second mode, whether the touch panel is touched in a second cycle longer than the first cycle.

5. The image forming apparatus according to claim 1, wherein
the touch panel includes
a plurality of pattern wirings, and
an identification circuit that identifies whether the touch panel is touched based on a detection signal detected from a detection wiring among the plurality of pattern wirings, wherein
the identification circuit generates a comparison signal indicating a potential according to a degree of difference between a waveform of the detection signal and a waveform of a reference signal detected from the detection wiring when the touch panel is not touched, and wherein
the identification circuit
identifies, in the first mode, whether the touch panel is touched when a potential indicated by the comparison signal equal to or higher than a first threshold value potential, and
identifies, in the second mode, whether the touch panel is touched when the potential indicated by the comparison signal is equal to or greater than a second threshold value potential lower than the first threshold value potential.

6. An electronic device comprising:
a display that displays information to a user;
a capacitive touch panel that receives an instruction from a user;
a power supplier that supplies power to the display and the touch panel; and
a controller that controls the display, the touch panel, and the power supplier, wherein
the controller is configured to control
a first mode in which the power supplier is controlled so that power is supplied from the power supplier to the display and the touch panel and
a second mode in which the power supplier is controlled so that a power supply from the power supplier to the display is restricted, and power is supplied from the power supplier to the touch panel, and wherein
an amount of power supplied from the power supplier to the touch panel in the second mode is smaller than an amount of power supplied from the power supplier to the touch panel in the first mode.

7. The electronic device according to claim 6, wherein
the touch panel includes a plurality of pattern wirings, wherein
the touch panel
identifies, in the first mode, a touch position on the touch panel based on a signal detected from a first detection number of pattern wirings among the plurality of pattern wirings, and
identifies, in the second mode, whether the touch panel is touched based on a signal detected from a second detection number of pattern wirings that is fewer than the first detection number among the plurality of pattern wirings.

8. The electronic device according to claim 6, wherein
the touch panel includes a plurality of pattern wirings, wherein
the touch panel
identifies, in the first mode, a touch position on the touch panel based on a signal detected from a detection wiring different from the drive wirings among the plurality of pattern wirings
when each of a first reference number of pattern wirings among the plurality of pattern wirings is selected as a drive wiring, and
a drive signal is supplied to each of the first reference number of drive wirings, and
identifies, in the second mode, whether the touch panel is touched based on a signal detected from the detection wiring
when each of a second reference number of pattern wirings that is fewer than the first reference number among the plurality of pattern wirings is selected as a drive wiring, and
a drive signal is supplied to each of the second reference number of drive wirings.

9. The electronic device according to claim 6, wherein
the touch panel
identifies, in the first mode, a touch position on the touch panel in a first cycle, and
identifies, in the second mode, whether the touch panel is touched in a second cycle shorter than the first cycle.

10. The electronic device according to claim 6, wherein
the touch panel includes
a plurality of pattern wirings, and
an identification circuit that identifies whether the touch panel is touched based on a detection signal detected from a detection wiring among the plurality of pattern wirings, wherein
the identification circuit generates a comparison signal indicating a potential according to a degree of difference between a waveform of the detection signal and a waveform of a reference signal detected from the detection wiring when the touch panel is not touched, and wherein
the identification circuit
identifies, in the first mode, whether the touch panel is touched when a potential indicated by the comparison signal equal to or higher than a first threshold value potential, and
identifies, in the second mode, whether the touch panel is touched when the potential indicated by the comparison signal is equal to or greater than a second threshold value potential lower than the first threshold value potential.
